(19) United States
(12) Patent Application Publication
(10) Pub. No.: US 2013/0132422 A1
(43) Pub. Date: May 23, 2013

(54) SYSTEM AND METHOD FOR CREATING AND CONTROLLING AN APPLICATION OPERATING ON A PLURALITY OF COMPUTER PLATFORM TYPES

(71) Applicants: Matt Rogish, Astoria, NY (US); Aaron Radin, Brooklyn, NY (US)

(72) Inventors: Matt Rogish, Astoria, NY (US); Aaron Radin, Brooklyn, NY (US)

(73) Assignee: Toura, LLC, New York, NY (US)

(21) Appl. No.: 13/328,580

(22) Filed: Dec. 16, 2011

Related U.S. Application Data
(60) Provisional application No. 61/561,389, filed on Nov. 18, 2011.

(51) Int. Cl. G06F 17/30

(52) U.S. Cl. 707/769; 707/825; 707/E17.005; 707/E17.014

(57) ABSTRACT

This invention discloses a novel system and method for organizing content to be use in the creation, operation and updating of applications that target multiple types of computer platform types such that the author creates one version of the content and application, which is automatically formatted for the entire set of targeted computer platform types and further when maintenance or updating of the content occurs, only one set of data files needs updating.

### PRIORITY CLAIM

This application claims priority as a non-provisional continuation of U.S. Patent Application No. 61/561,389 filed on Nov. 18, 2011 which is herein incorporated by reference in its entirety.

### FIELD OF INVENTION

This invention is related to the production, distribution and operation of applications that can operate on a panoply of computer platform types, including different kinds of laptops, tablets, smartphones or desktop computers that run under different operating systems or other kinds of run-time environments.

### BACKGROUND

In a typical software development environment, an application that is designed to present changing or dynamic content to a mobile device is produced or “authored” by creating code that the specific computer platform device can then execute and render for display or audio output. Similarly, the code that executes on the device can respond to tactile, voice or typewritten commands. The problem for authors of these applications is that there are many possible computer platform devices, each with its own screen size, native browser code, operating system or other attributes. This means that the author has to create and maintain many different versions of the same application. For websites or other environments that attempt to support many different computer platform devices, the task of preparing dynamic content and presentation of such content on each type of device is also complex. Therefore, there is a need for a system and method to automatically generate multiple versions of content from one version of content.

### DESCRIPTION OF THE FIGURES

FIG. 1. Flow chart showing components of authoring tool to produce an app.

FIG. 2. Flow chart showing input steps.

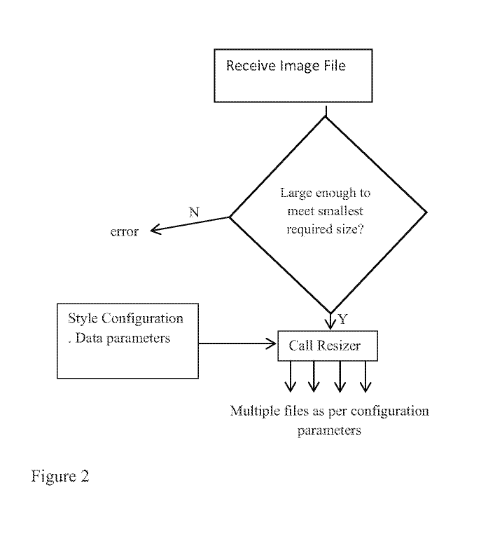

FIG. 3 Schematic of JSON hierarchy.

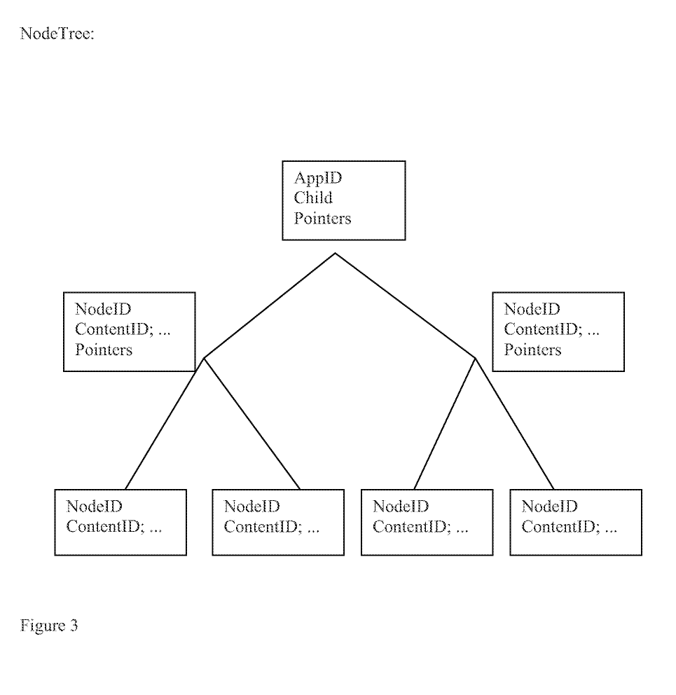

FIG. 4 Architectural diagram

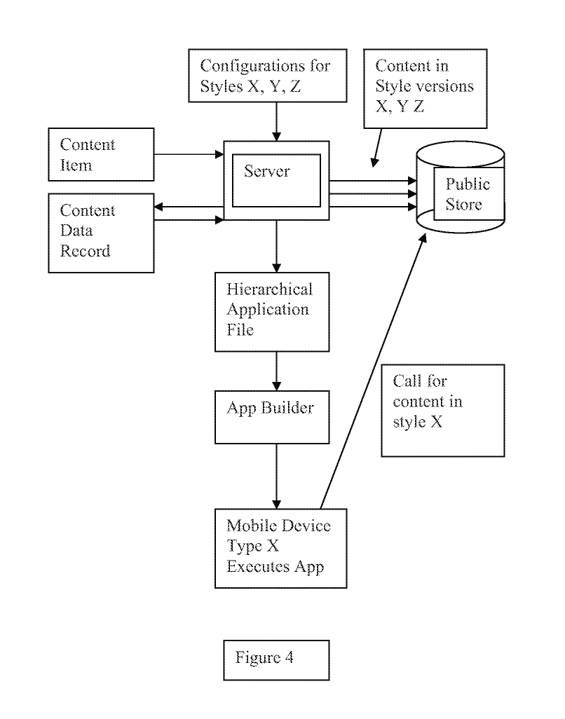

### DETAILED DESCRIPTION OF THE PREFERRED EMBODIMENTS

An example of a multi-platform system for displaying content on a variety of devices is comprised of an application (or “app”) and a browser that operates on a computer platform type. The browsers for each computer platform type may be unique to the type. Therefore, the application as a file contains data that all of the target computer platform browsers can use. In this manner, the same application file is distributed to all of the computer platform types. In addition, a script file is delivered to the variety of computer platforms. The script executes on the browser. One purpose of the script is to establish a global variable on the computer platform that indicates the type of computer platform or browser that is executing the script and thereby displaying the application. As a result, the script can then use that global variable as a condition in branching statements in the scripted program that select which entries in the application file to rely on. For example, if the running script determines that it is running on an iPhone™, then its branching statements will always select location references in the application file that are specified for the iPhone or iOS system. When the script executes the application, it will call for certain content, for example image files. The image file reference may be a URL, (Uniform Resource Locator) which is an example of a location reference to that resource. In this method, the image file is referenced abstractly. As a result, the application looks to the application file to find the location of the referenced image file. However, at that point, the URL reference that is handed back is dependent on the type of computer platform that is stored as the global variable driving selecting logic through the conditional branching statements. In this way, the application file can contain under the reference for the specific image file, a plurality of URL's that correspond to the type of computer platform that is to display the image. For example, the image in all cases may be the same, but the size of the image will vary depending on what device platform is intending to display it. The example given above describes the resource as an image, but other content can be used, for example, audio data files, video data files, text data files, live data feeds, for example, streamed audio, news tickers and the like, or even map location data. Besides URL's as a reference, references can also be IP addresses with filenames, NFS addresses or any other string of text that addresses a remote data resource.

In another embodiment, the application file is comprised of data structured in a hierarchy, in one embodiment, this hierarchy is created by means of the standard JSON file construct. In an example of one type of content, not meant to limit the claimed invention, on the server, authoring tool automatically resizes a single image into several versions so that it properly displays on a plurality of corresponding computer platform types. This program can also store the URL's associated with each resized image version, placing each URL text in the hierarchy in the file so that the appropriate computer platform type is associated with the correct URL that references the resized image version appropriate for that computer platform type. Analogously, other types of content may be customized for each type of platform. For example, an audio file may be in the MP3 codec for one platform type while placed into the Ogg Vorbis codec for another. The appropriate URLs for these two compressed audio files are placed in the application file at the correct place in the hierarchy associated with the platform types that require the respective compressed audio codec types.

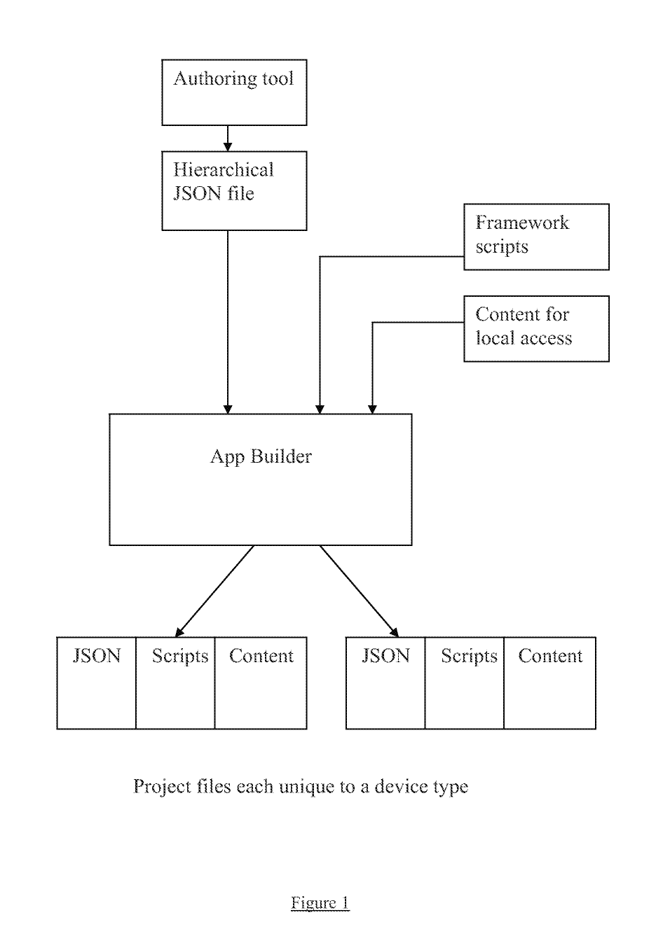

Production of applications that exploit the system is by means of several components. In FIG. 1, the architecture of the creation environment is presented. Pre-defined templates are created for each target computer platform type. Alternatively, a template is created that can service all of the target computer types if the content for the application is modified for each type. In addition, content, which includes video, audio, images and text are referenced by the application. In one embodiment, the App is comprised of content to be stored locally on the device, a script file and the hierarchical file, that in one preferred embodiment is a JSON file.

The App Builder generates the application file that contains the hierarchy of references to content and other items organized by the platform type. In one embodiment, the App Builder generates a compressed data file containing the application file, script files and HTML. In another embodiment, the compressed data file also contains object code for the components or browser of a given computer platform type. In yet another embodiment, the App Builder outputs a number of compressed data files, each containing the appropriate object code for a corresponding computer platform type.

In yet another embodiment, the application can utilize certain cross-platform frameworks. In this mode, the App Builder generates a compressed data file that contains the utilities and other native object code for a computer platform type that is generated using the cross-platform framework. For example, the cross-platform framework may already have a code object for displaying images or playing sounds. In the cross-platform framework, this is presented as specific commands in a typical language, for example HTML 5. The author can then rely on writing the application using HTML 5 commands to access functionality in the computer platform hardware. Alternatively, the component abstraction layer in the templates can call the HTML 5 commands and thereby include any other information or specification determined by the template itself. The cross platform framework can translate between resources called for in HTML 5 and exercising the API's (application program interface protocols) associated with the resource on each specific target computer platform type. In some cases the cross-platform framework consists of native application code that provides the native browser with additional functions that can be called by the application through the scripting code that comprises the application. The App Builder uses the cross-platform framework by including the native code components for each corresponding one of the target computer platform types.

The first step in using an App Builder to create a cross platform compatible App is to organize the content. The content is organized using a database. The database typically has a data record that represents the item of content. The database record may contain references to where the different versions of the content are stored. Finally, the variants in the content file are automatically created and are used to populate a publicly accessible server. The location of the variations are stored in the database for use later. The steps executed by the server may include:

1. Upon upload of content to the content management server

2. Create blank database record for the piece of content

3. Create the content style variants and provide filenames

4. upload the content style variants to the publicly available server in a specified directory, or create a directory as needed

5. Derive a URL (or other location reference to the content variations) from the directory hierarchy on the publicly available server and filename.

6. Populate the Database record with the derived URL's or location references

Once the content has been uploaded, a app builder command can be executed which causes the creation of the application, especially the hierarchical application file itself.

In a system for organizing the content, there will be additional steps. For example, the system can check that the original instance of the content meets some criteria. In one embodiment, any image file checked that its size meets the smallest size requirements for the resizing step. The system uses a style configuration file to define several categories of content versions. This file contains configuration data that informs the versioning module what kinds of versioning of the content is required. For example, for one category of version, all images may be turned into JPEG's, while for another, PNG files. The configuration file can comprise data that indicates that for one category of version, the images are 100 by 200 pixels, while in another, 1000 by 2000 pixels. This configuration data, in the case of images, is used to cause the versioning module to resize a single image file into several different image files that conform to the category of versions indicated in the style configuration data file.

The system also organizes all of the content, including the different versions of the content in a database. The organization will be explained in terms of images, but other content types, including audio clips, video and text can be organized the same way. In one embodiment, the images are stored in a directory where each image is a file with a filename identifier comprised of the organization id and an image id, for example: {organization=id|image id}. file is stored in a directory path of: root/orgname/images/filename.original.type, where the organization is the name of the owner of the content. In addition, a record is created in a database representing the content item, referenced in this example by the image id. The attributes for that data record include the organization id, image id and various style types. The database is also comprised of a data table with rows as follows:

### Images:

ID name|creator art|original URL|Gallery style type URL|other style type URL's|

The original URL is a reference to the location of the original content file. The Gallery URL is a reference to the publicly available location of the version created for the style called “Gallery”, and so on with the other style type URL's. The URL's present in the “images” table include the URL's that end up in the hierarchical application file, which in one embodiment, is the JSON file.

The system also creates a Node tree representing the organization of the app as the presentation to the user. For example, the application may have a home page, which is the root of the tree, and then two sub-pages, which would be two branches from the root. These two sub-pages may have two more pages each, for a total of 7 pages making up the application. The tree structure is organized into Nodes. Each Node has content associated with it. A template is a file that determines for a specific template, the organization of Nodes and what content style types are associated with each Node in the tree. The system can then perform the following process to create a Node tree for an application:

Create NODE tree:

1. create App

2. select first Node

3. select template

4. select content to associate with current node, original files.

5. for NODE background, select image “property”
for NODE images, select image(s)

6. Select additional child node or nodes.

7. Go to step 4 unless finished.

The Node tree is represented by a table data structure where each Node has a Node ID a Parent ID and one or more Child ID's. That is a list of Nodes where each entry on the list is

### [NodeID, ImageID1, ImageID2, . . . Parent Node ID, Child Node ID, Child2 NodeID, . . . ].

When the app builder is called to build the application file, it is creating the hierarchical application file, which in one embodiment is the JSON file. An app will also have metadata associated with it, for example, the owner of the app, the name of the author, the date of creation, tour-id, etc. The process steps to create that file may include:

1. Receive command to make Application file.

2. Retrieve App Information metadata and insert metadata into Application file

3. March through Nodes referenced in the Node tree by querying the, NODE table using the entry ID, to fetch the ImageID for the current node.

4. Query content database to find all of the URL references for the style types associated with that imageID.

5. Insert into the Application file the URL references from the query in the prior step as text strings embedded in the hierarchy.

We map images to nodes and the device and at run time based on that information, the displaying device picks the style and formulates a request to the server for the content in that style.

For each NODE, there is one or more references to the original imageID, which is platform agnostic. Once the imageID for a Node is known, the content database can provide the URL's for each version of the image for each required style type for that Node. In another embodiment, another intersection table can be used that maps Node ID's to the Image ID's. In yet another embodiment, the URL's can be stored directly in the Node table entries. In this embodiment, the app operating on the target platform determines which style version of a piece of content to select. The scripts running on the device determine that the platform is of some type, X, for example and then scans the Application file for the references to the same contentID and then selects a URL based on the style that the script has determined is required. Given that style requirement, the running app can then extract the appropriate URL and fetch that file from the remote server.

In yet another embodiment, an intersection table can map the NodeID's to the style type for that node. In this embodiment, each style type can have several versions of the content, or image, each specific for a target platform type. For example, a template may specify that for a particular Node in the template, there is a “thumbnail” of an image that is placed in the upper right hand corner of the screen. That style type “thumbnail” may have four different variations, depending on whether the target platform is a Blackberry™ device, iPhone™ device, iPad™ device or laptop computer browser. In one, the “thumbnail” may call for a 120 pixel by 120 pixel image, while another, a 400 pixel×400 pixel version of the image. In this embodiment, then, there are two tables: one maps the NodeID to the ImageID and the other maps the NodeID to the style type. As a result the program creating the hierarchical application file can use the first table to fetch the ImageID and the second to fetch the styletype. Using the ImageID and the styletype, the program can fetch from the content database the URL's for the image variations appropriate for the styletype for the various platform types. These URL's are text strings that are then stored in the Application hierarchy file under the reference for that piece of content, that is, the image ID. In this embodiment, the running app can does not need to determine the appropriate style type to display a particular piece of content. This has already been determined in the Application file. The running app simply scans the Application file using the platform type variable to match it with the URL associated with the ContentID under that platform type.

In another embodiment, the last step puts the URL's or references to the content in the hierarchical presentation in the application file. In another embodiment, the hierarchy has identifiers placed in the hierarchy and at the bottom of the application file, a list of identifiers with the URL's in an intersection table. These URL's are references to the content versions appropriate for that specific Node, which has a style. The second embodiment makes it easier to avoid having many references to the same file rather than one short reference to an interim location where the short reference is mapped to the complete URL to the content version. In the preferred embodiment the output has the form as shown below. In the first instance, the Application file is laid out so that each ContentID has multiple URL's associated with it where each column represents a different style type:

Application File

Metadata, e.g. Tour Name—NODE TREE

[Node ID1, Parent ID, Child ID1, Child ID2, . . . , Content ID1, Content ID2 . . . ]

Items:

Content ID1, URL1, URL2, . . .

Content ID2, URL2 URL2, . . .

In the second example, the Application file is laid out so that the style type is already determined and the running app is simply determining based on the platform type which

URL to select:

Application File

Metadata, e.g. Tour Name—NODE TREE
Node ID1, Parent ID, Child ID1, Child ID2, . . . , Content ID1, Content ID2 . . .

Items:

### Platform X

Content ID1, URL1

### Platform Y

Content ID1, URL2

### Platform Z

Content ID1, URL3

Updating an application across the platform types is simplified by means of the invention. In one embodiment, when an object in the application is updated, the entire application file can be replaced. When the script running on the computer platform first launches, it can check whether it has received the latest version of the application file. A message is transmitted from the computer platform to a central server to obtain data indicating whether or not the application file or script file is current. This may be data representing a time stamp that may be compared with the time stamp of the corresponding files already stored on the device. If the instance of the application is not current, the application file is downloaded to the platform device and as a result, the new object will be rendered because the URL reference for it is already present in the replaced application file. In another embodiment, the application file can remain static. In this embodiment, the program that performs the resizing on the server, for example, can then update the contents of computer memory referenced by the URL's that were already distributed within the application file. Other types of content can be updated analogously.

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture does not limit the claimed invention. Further, the user's computer platform device may be a laptop or desktop type of personal computer. It can also be a cell phone, smart phone or other handheld device. The precise form factor of the user's computer platform device does not limit the claimed invention. Further, the customer may receive from and transmit data to the central server by means of the Internet, whereby the customer accesses an account using an Internet web-browser and browser displays an interactive web page operatively connected to the central server. The central server transmits and receives data in response to data and commands transmitted from the browser in response to the customer's actuation of the browser user interface. The program can detect the relative location of the cursor when the mouse button is actuated, and interpret a command to be executed based on location on the indicated relative location on the display when the button was pressed. Similarly, the program can detect the location of a touch on the screen. The data file may be an HTML document, the program a web-browser program and the command a hyper-link that causes the browser to request a new HTML document from another remote data network address location. The data file may also contain scripts, which are computer program commands, which are executed by the browser. The data file may also contain references to objects stored either locally or remotely that the browser may then access and display or otherwise render. The browser can thereby fetch additional data that is stored on a remote server accessed using the Internet.

The Internet is a computer network that permits customers operating a personal computer to interact with computer servers located remotely and to view content that is delivered from the servers to the personal computer as data files over the network. In one kind of protocol, the servers present webpages that are rendered on the user's computer platform using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Examples of well known computing platforms, systems, environments, and/or configurations that may be suitable for use with the invention include, but are not limited to, personal computers, server computers, hand-held, laptop, tablet or mobile computer or communications devices such as cell phones, smart phones and PDA's, multiprocessor systems, nmicroprocessor-based systems, set top boxes, programmable consumer electronics, network PCs, minicomputers, mainframe computers, distributed computing environments that include any of the above systems or devices, and the like. These may operate using as an operating system Windows, iOS, OSX, Android, Linux, Unix, Symbian and Blackberry including the various versions and variants thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., a scripting language, like JAVA, Java Script an assembly language, or a high-level language such as FORTRAN, C, C++). The source code may be compiled before execution and distributed as object code that is executed on the target computer or compiled as it is executed by the target computer, in each case for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed is:

1. A method for organizing content for use in an application usable by a plurality of computer platform types comprising:
Receiving a content file;
Generating and storing a database record associated with the content file.
Generating and storing in a plurality of computer memory locations a corresponding plurality of content file versions, each version of a style type, each derived from the received content file;
Generating a plurality of location references from the directory and filenames associated with the stored plurality of content file versions;
Populating the database record with the location references, where each location reference is associated in the data record with a version style label.

2. A method for organizing content for use in an app usable by a plurality of computer platform types comprising:
Generating and storing an app file;
Selecting a blank node;
Selecting a template associated with the blank node;
Selecting a content file to be associated with the blank node
Selecting a plurality of additional nodes and continuing to associate additional content files with the plurality of additional nodes; and
Generating a data structure representing the node tree using the selected nodes and selected additional nodes and storing the data structure in a computer memory.

3. The method of claim 2 further comprising:
Receiving a selection of a node in an app;
Receiving a selection of a background image to be associated with the selected node or an image property or selecting a Node image and selecting an image.

4. The method of claim 2 further comprising:
Receiving a selection of a node in an app;
Receiving a selection of a node image type to be associated with the selected node and receiving a selection of an image to be associated with the node.

5. The method of claim 1 further comprising determining whether the received content file is an image and testing to determine whether the received image file meets a predetermined minimum size.

6. The method of claim 1 further comprising:
Retrieving from computer memory a plurality of configuration data associated with the plurality of style types that specifies how to generate the plurality of content versions in the corresponding plurality of style types.

7. A method for organizing content for use in an app usable by a plurality of computer platform types comprising:
Sequentially selecting a plurality of nodes referenced in a node tree data structure, and for each selected node:
Retrieving the node identifier associated with the selected node;
Retrieving from a node table entry associated with the node identifier a reference to a content identifier;
Retrieving from an intersection table that maps node identifiers to content style types a location reference to the content style version of the content associated with the referenced content identifier;
Storing in the app file the retrieved location references.

8. A method of creating an app comprising:
Receiving data representing a command to make the app file;
Creating in computer memory an app file;
Retrieving from computer memory metadata associated with the app and storing said metadata into the app file;
Sequentially selecting nodes associated with the app and fetching a content identifier associated with the selected node;
Querying a content database to retrieve all of the location references for the style types associated with the fetched content identifier;
Storing in the app file the retrieved location references.

9. The method of claim 8 further comprising:
Organizing in the app file the retrieved location references for all of the content associated with the app in a hierarchy.

10. A method of creating a data file representing an app comprising:
Executing the steps of claim 1, 2, 8.

11. A computing device adapted to execute any of the methods of claims 1-10.

12. A computer readable medium containing programming code data that when executed by a computing device, causes the computing device to perform any of claims 1-10.

13. A computer system comprised of one or more data base servers that is adapted to execute the methods of either claim 1, claim 2 or claim 8.

14. A system for organizing content to be retrieved by a plurality of remote computer device types comprising:
A data store containing a plurality of versions of a content file, each said version compatible with a device type;
A server adapted to receive a request for the content file from one of the remote computer devices, said server adapted to determine the style type of the content file being requested and further adapted to retrieve and transmit to the requesting remote computer device the version of the content file associated with the requested file type.
